(19) United States
(12) Patent Application Publication
(10) Pub. No.: US 2007/0083329 A1
(43) Pub. Date: Apr. 12, 2007

(54) Location-based interactive web-based multi-user community site

(76) Inventor: Wansoo Im, West Windsor, NJ (US)

Correspondence Address: FOX ROTHSCHILD LLP;PRINCETON PIKE CORPORATE CENTER, 997 LENOX DRIVE, BUILDING #3, LAWRENCEVILLE, NJ, 08648, US

(21) Appl. No.: 11/545,684

(22) Filed: Oct. 10, 2006

Related U.S. Application Data
(60) Provisional application No. 60/724,709, filed on Oct. 7, 2005.

(51) Int. Cl. G06F 19/00

(52) U.S. Cl. 702/5

(57) ABSTRACT

The present invention comprises a system for creating a multi-user internet community site with location-based information (Geographic Information System). Location-based information is maintained by the community of users in a manner similar to blog content (text, photos) and is managed in a manner similar to presently existing multi-user sites (such as Flickr.com, MySpace.com, TheFacebook.com). Community groups, organizations, or individuals can create a free or fee-based account and launch their own multi-user website with a location-based component. All information has a location-based component. Location information can be added and updated through a variety of geospatial reference methods (e.g., latitude and longitude, or UTM, or State Plane). Either by using GPS-collected data, or through direct user interaction with the map (e.g., a user can click on the interactive map and store information with spatial references). Preferably, all information can be added and updated via a browser or other device over the Internet. Digital photos, videos, sounds, or other multimedia content created with a mobile device with GPS capabilities can be sent directly to the website along with their with spatial reference, for sharing with a community or other individuals.

### BACKGROUND OF THE INVENTION

The primary function of the site is to organize and archive location-based community or other service provider information in an interactive way.

At present there are many websites which provide information in an Internet mapping format. All of these sites are pre-packaged and pre-customized Internet applications. None of them provides bidirectional information flow.

### SUMMARY OF THE INVENTION

The present invention comprises a system for creating a multi-user internet community site with location-based information (Geographic Information System). Location-based information is maintained by the community of users in a manner similar to blog content (text, photos) and is managed in a manner similar to presently existing multi-user sites (such as Flickr.com, MySpace.com, TheFacebook.com). Community groups, organizations, or individuals can create a free or fee-based account and launch their own multi-user website with a location-based component. All information has a location-based component. Location information can be added and updated through a variety of geospatial reference methods (e.g., latitude and longitude, or UTM, or State Plane). Either by using GPS-collected data, or through direct user interaction with the map (e.g., a user can click on the interactive map and store information with spatial references). Preferably, all information can be added and updated via a browser or other device over the Internet. Digital photos, videos, sounds, or other multimedia content created with a mobile device with GPS capabilities can be sent directly to the website along with their with spatial reference, for sharing with a community or other individuals.

### BRIEF DESCRIPTION OF THE DRAWINGS

FIGS. 1 and 2 illustrate a browser view of an interactive mapping site which enables the storage, query and view of HIV service providers' information in a web-based mapping format according to the present invention.

FIGS. 3 and 4 illustrate the browser display of an overall map of a geographic region and a query for available categories of data associated with a community website.

FIG. 5 illustrates the browser display of the details of data for a particular location including e.g., a picture.

FIGS. 6 and 7, illustrate input screens for inputting data associated with a selected location.

FIG. 8 illustrates a GIS displaying an interactive map of Manhattan in New York City.

FIG. 9 illustrates a GUI for displaying data associated with particular location on the interactive map of FIG. 8.

### DESCRIPTION OF THE INVENTION

The new interactive mapping site and web-based system of the present invention has the following functionality:
Ability to assign geographic reference to any object or piece of information through one of several methods, or a combination thereof (either with Global Positioning Systems receiver (GPS) or map reference). For example, a user can click a location on a map, and data will be assigned with latitude and longitude to that location (with spatial reference).
Users can find any information (including photos, texts, images, links, and other multimedia content) based on a location-based query in addition to an attribute-based query. For example: “Find all post-modem architecture buildings in SoHo,” or “Find all photos of dogs that were taken in Central Park.”
All above functionality can be provided automatically for registered users. Users preferably can create free accounts with basic functionality, or fee-based accounts with extended functionality.

In one embodiment, users can take pictures with GPS-equipped digital cameras, and send the photos (with their location data) to the server for storage and display on a map. The GPS-equipped camera may, for example, be part of a mobile camera phone. The picture and location data may be transmitted via the wireless network and/or the Internet to a central database of databases. This feature can be applied to any other multimedia file, such as video, sound, etc.

Heretofore, interactive mapping sites where users can create their own location-based online community by creating their own interface are not known.

The interactive mapping site of the present invention may be implemented on a proprietary Geographical Information System (GIS) such as is available from ESRI or on publicly available GISs such as Google Maps or Mapquest.

A record of data for a particular location may be added to a database. The database may comprise one or more layers of the GIS. In one embodiment, the data for each record, is added or editable by multiple users through an onscreen GUI interface. In a preferred embodiment the GIS is viewed through a browser such as Microsoft Explorer and the interface is programmed in Java programming language. Typically, an icon indicating the presence of data for a location is displayed on the GIS. The precise nature of the data will vary according to the nature of website or community of users.

A key feature of the interactive website is the functionality of permitting multiple users to input data onto the GIS, preferably by multiple means, e.g., direct entry through the GUI or via mobile units with GPS capabilities.

In another aspect, the invention comprises a business method whereby multiple websites are hosted on a server or servers. Access to the websites may be regulated by passwords and fees, such as subscription fees, are charged for access and/or hosting. The users can define what types of attributes or descriptive information that the community will collect and store in the website database. Multiple sets of databases can be used in a single website. Typically, each database or set of databases will define a layer on the GIS.

### EXAMPLES

### Example 1

### HIV Resource Inventory

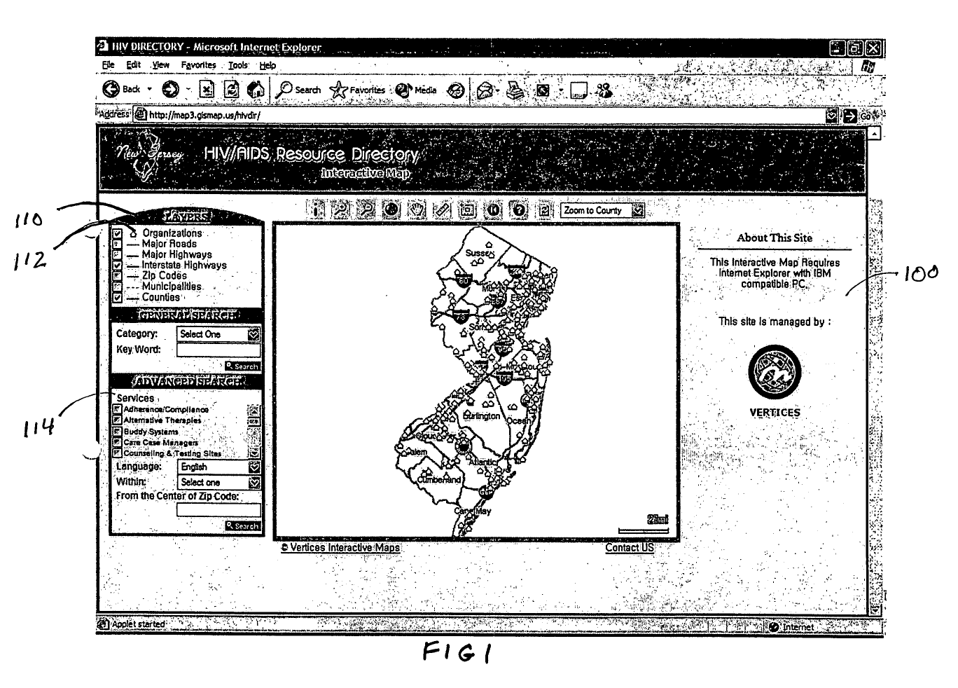

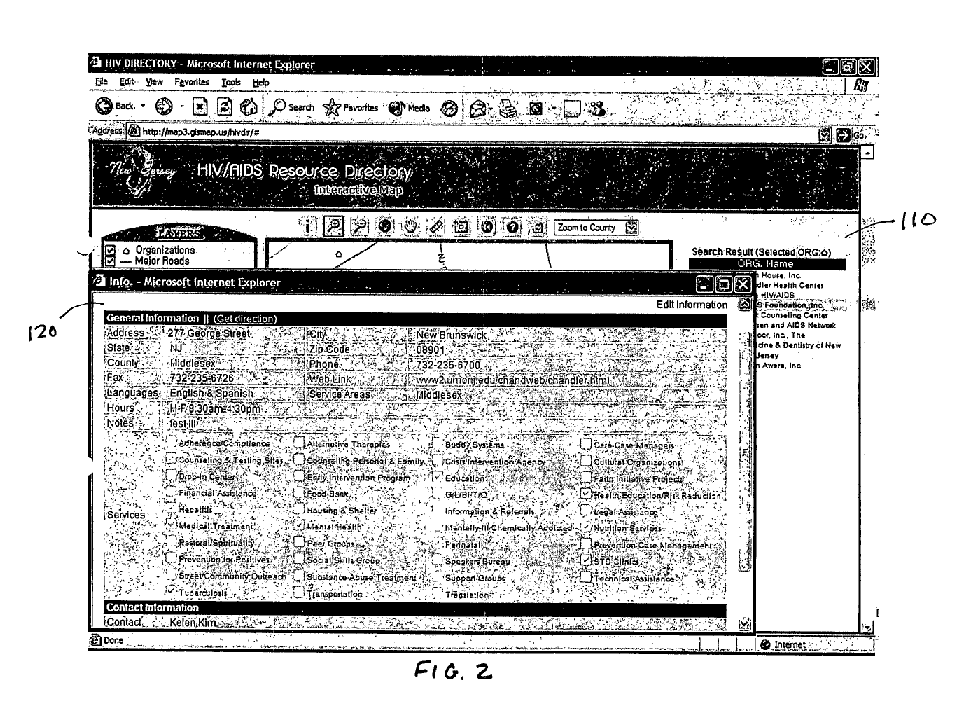

As illustrated in FIGS. 1 and 2, this interactive mapping site 100 enables the storage, query and view of HIV service providers' information in a web-based mapping format. Each service provider preferably has their own password-protected account, and the ability to update their information via the Internet in real time. The information, including point location, can be updated via the Internet. The GUI displays typical GIS layers 110 such as roads, zip codes, and municipalities. It also displays an organization layer 112 which indicate the geographic location for which descriptive data are entered into the system database. The system has an advanced query interface 114 which permits searching by typical GIS data types such as zip code and distance as well data attributes of the data fields associated with the organizations such as whether the organization offers alternative therapies, adherence/compliance, buddy systems, etc.

FIG. 2 illustrates the data input window 120 for information relevant to HIV services providers, e.g., services available at the location, street address, phone number, etc.

### Example 2

### My Favorite Places in West Windsor

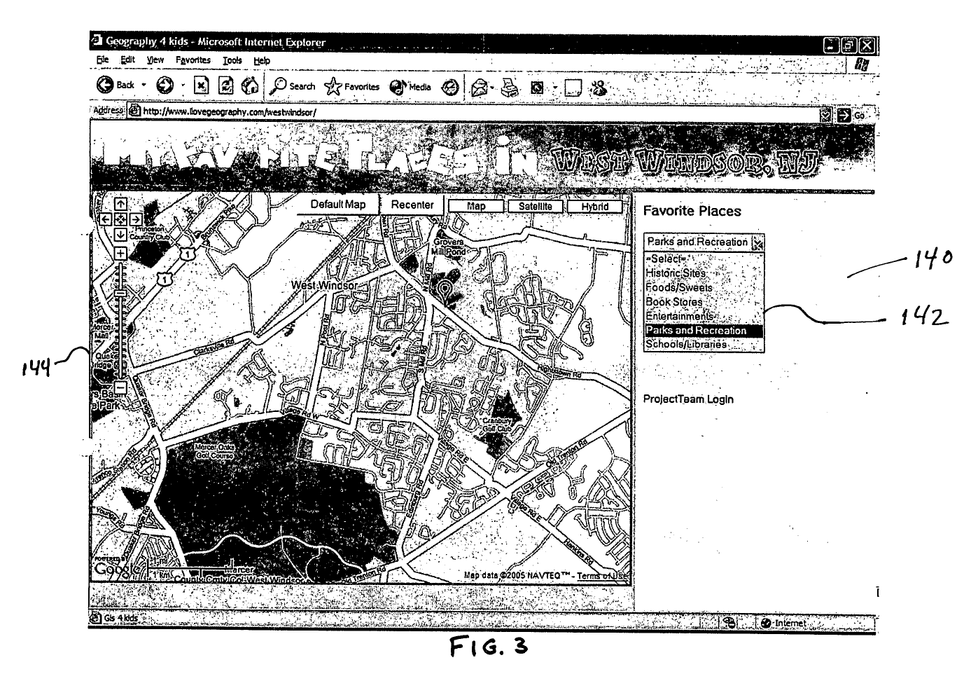

With reference to FIG. 3, this website 140 is developed to assist school children in collecting and sharing community data such as locations of (and information about) parks and recreation facilities, schools, libraries, foods/sweets shops, etc. The location information can be updated with GPS-collected point data (latitude and longitude), or simply by clicking on a map to get latitude and longitude. The location and attribute (descriptive) information is entered into a database on an Internet server via input interface and other visitors can query and view the information through the query interface 142. The users can also update or edit the attribute data for the location data.

This particular site is developed using the Google Maps API Beta version. The same application can be developed with the MapQuest API or the Yahoo! Maps API. The map API can also be developed using proprietary map services such as are available through ESRI or Vertices LLC.

The business method is that users create their own location-based interactive mapping community sites by using, for example, Internet applications available from Vertices, Inc. The user can define what kinds of location data they want to use and what kinds of attribute (descriptive) information they want to use with the interactive, Internet-based database. The applications can range from school projects and retail providers location data, to any online community project.

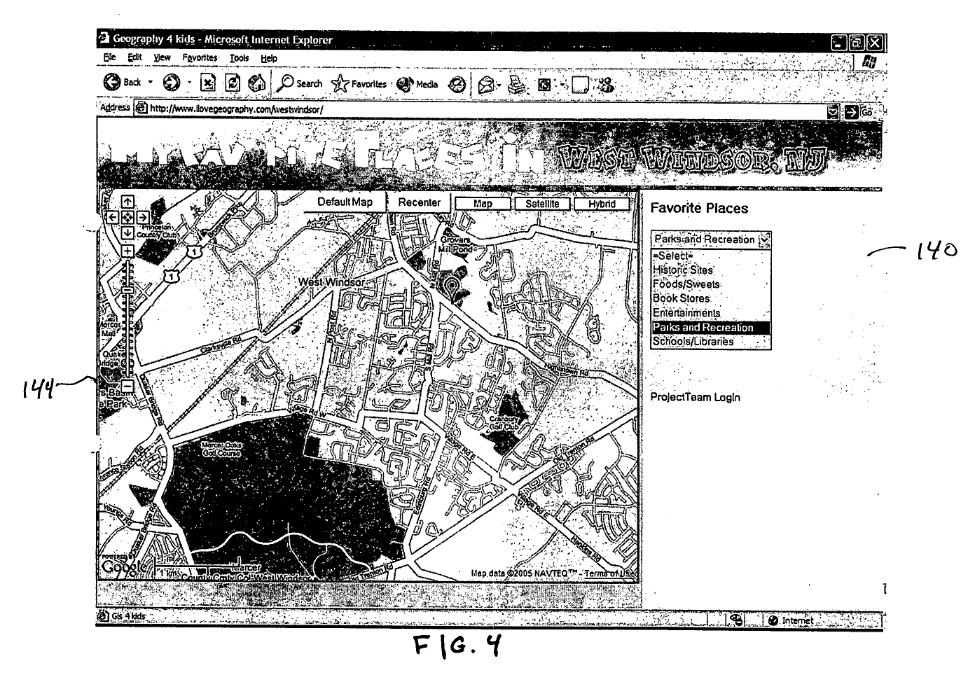

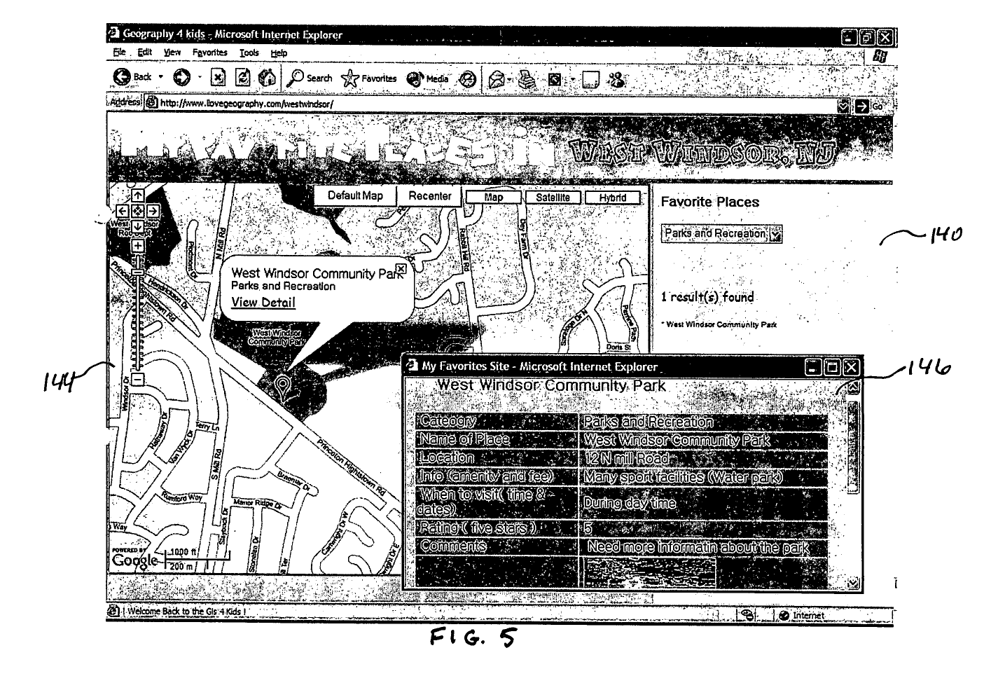

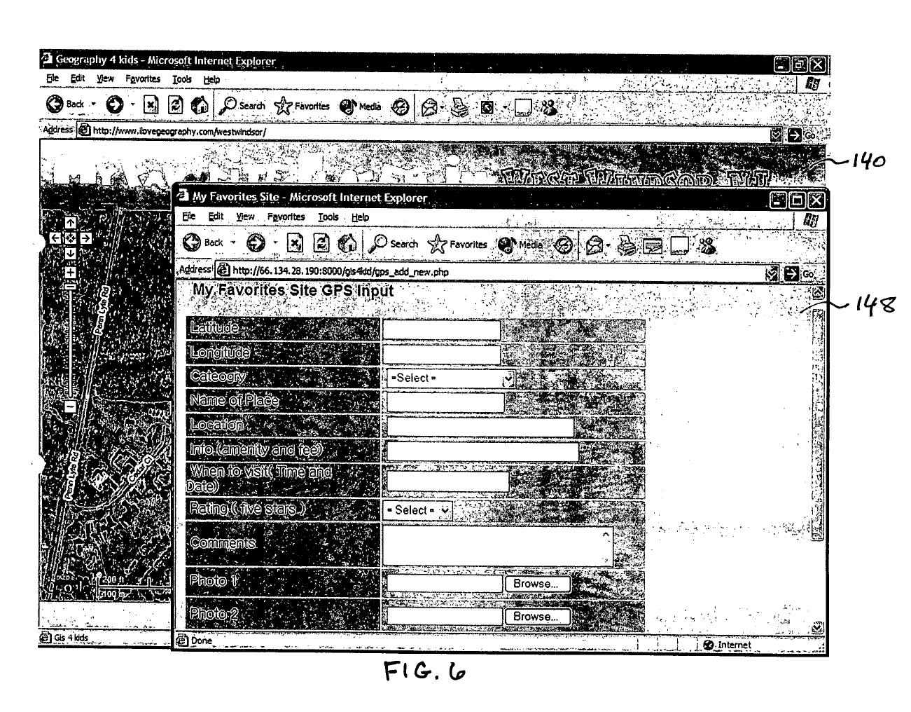

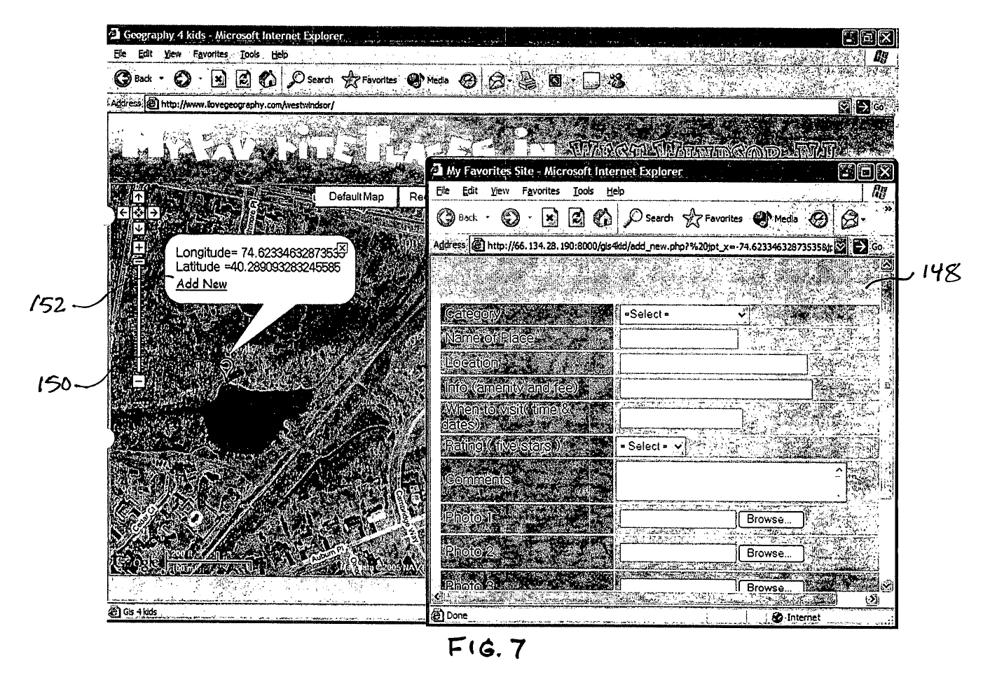

FIGS. 3 and 4 illustrate the display of an overall map 144 of a geographic region and a query 142 for available categories of data associated with the website. The display uses the Google Maps API which provides the underlying map information. FIG. 5 illustrates the display 146 of the details of data for a particular location including e.g., a picture. In this embodiment a brief description of the record of data, e.g., a community park, is displayed when the curser does a mouse-over the icon indicating an available record of data. FIGS. 6 and 7, illustrate input screens 148 for inputting data associated with a selected location 150 having the latitude and longitude shown in display 152. The data types include category type for location, name of place, visiting hours, etc.

### Example 3

### Archive of Architecture

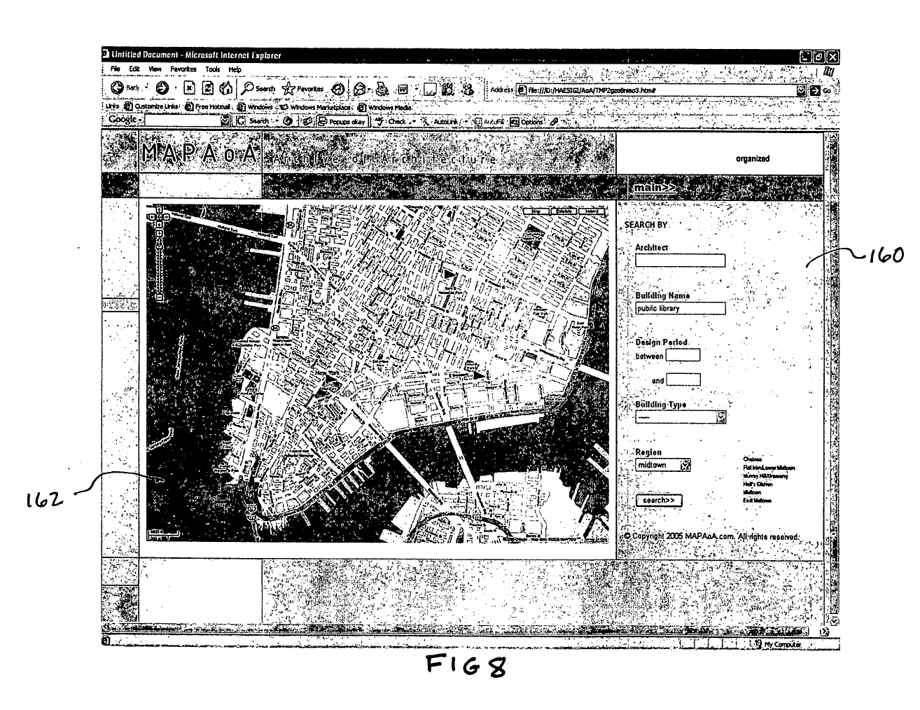

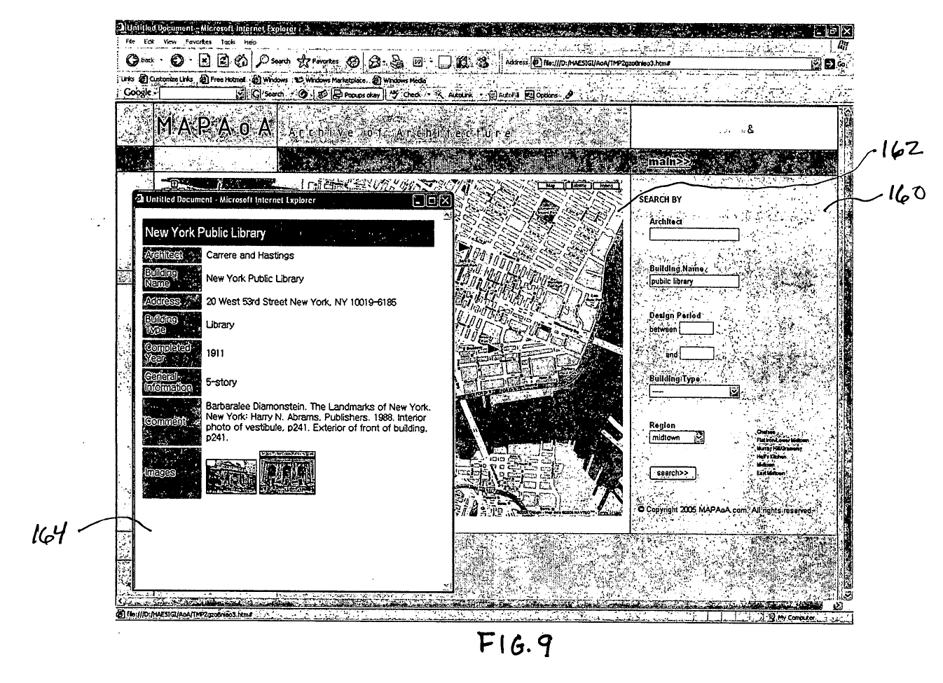

With reference to FIGS. 8 and 9, this website 160 allows community members (with free or fee-based user accounts) to add photos of existing buildings with specific architectural characteristics on an interactive map 162. The photos and their descriptive information can be directly input into the database via the interactive map. Location information is provided by the users by clicking on the interactive map.

The photos of the buildings and the related information (blueprints, sketches, or drawings) can be searched based on a spatial query and can be viewed on the interactive map.

FIG. 8 illustrates a GIS displaying an interactive map of Manhattan in New York City. FIG. 9. illustrates a GUI 164 for displaying data associated with particular location on the map.

What is claimed is:

1. An interactive web-based multi-user community site system comprising:
a geographical information system;
a database for storing descriptive data associate with a geographic location;
a web-based browser graphical user interface for displaying geographical information from the geographical information system and descriptive data from the database; and
a data input interface for inputting descriptive data into the database via the internet.

2. The community site system of claim 1, wherein the system further comprises a data display interface for displaying descriptive information associated with a geographic location in the geographical information system.

3. The community site system of claim 1, wherein the system comprises a plurality of data input interfaces for inputting descriptive data into the database via the internet.

4. The community site system of claim 1, wherein access to the database through the data input interface is restricted to selected users.

5. The community site system of claim 1, wherein the web-based browser graphical user interface comprises a map API.

6. The community site system of claim 5, wherein the map API is selected from Google Map API, Map Quest API and Yahoo! Map API.

7. The community site system of claim 1, wherein the data input interface is a web-based browser graphical user interface and comprises a map API.

8. The community site system of claim 7, wherein the map API is selected from Google Map API, MapQuest API and Yahoo! Map API.

9. The community site system of claim 1, wherein the data input interface is a mobile GPS device.

10. The community site system of claim 1, wherein the system further comprises a query interface for searching data in the database.

11. A system for generating an interactive web-based multi-user community site system comprising:
a geographical information system;
a database for storing descriptive data in a plurality of data fields in a data record associated with a geographic location;
a means for assigning attributes to data fields within the database;
a web-based browser graphical user interface for displaying geographical information from the geographical information system and descriptive data from the database; and
a data input interface for inputting descriptive data into the database via the internet.

12. The site generating system of claim 11, wherein the means for assigning attributes comprises a web-based browser graphical user interface.

13. A method for generating an interactive web-based multi-user community site system comprising:
providing a geographical information system;
providing a database for storing descriptive data in a plurality of data fields in a data record associated with a geographic location;
assigning attributes to data fields within the database;
displaying geographical information from the geographical information system and descriptive data from the database via a web-based browser graphical user interface; and
inputting descriptive data into the database via the internet.

14. The site generating system of claim 14, wherein the attributes assigned to data files are assigned via a web-based browser graphical user interface.
